(19) United States
(12) Patent Application Publication
(10) Pub. No.: US 2012/0310125 A1
(43) Pub. Date: Dec. 6, 2012

(54) CYLINDRICAL ROLLER MASSAGE TOOL

(76) Inventors: Wendell Hall, Bountiful, UT (US); Bradley B. Pitt, Kamas, UT (US); Cherimeer Lynn Pitt, Kamas, UT (US); Michele Hall, Bountiful, UT (US)

(21) Appl. No.: 12/942,026

(22) Filed: Nov. 9, 2010

Related U.S. Application Data
(60) Provisional application No. 61/280,848, filed on Nov. 10, 2009.

(51) Int. Cl. A61H 15/00

(52) U.S. Cl. 601/120

(57) ABSTRACT

A manually operated cylindrical roller is disclosed which facilitates the even application of pressure to the body tissue of a client during massage therapy, including tendons, ligaments, and muscles (e.g. the gluteus maximus, gluteus medius, sartorius, plantaris, and the like). Variations of the disclosed tool comprise inflatable and non-inflatable components, as well as foam components. The disclosed invention relieves sore and achy muscles, helps blood circulation, relieving muscle cramps, loosening tight and knotted muscles, and relieving pressure from the massage therapist's hands.

### CLAIM OF PRIORITY

This application claims priority to U.S. Provisional Patent Application No. 61/280,848, entitled E-ZZ roller massage device tool, filed on Nov. 10, 2009 with the U.S. Patent and Trademark Office (USPTO) and incorporated by reference.

### BACKGROUND OF THE INVENTION

1. Field of the Invention

This invention relates to massage tools, and more particularly relates to massage devices for applying rolling pressure to fascia, muscles, ligaments, tendons and joints.

2. Description of the Related Art

The present invention constitutes an addition and improvement to standard massage tools well-known and commonly available in the art. Traditional massage tools known in the art primarily comprise gripable, solid blunt objects for use by massage therapists in deep tissue massage, shiatsu, Bowen therapy, Balinese massage, and the like.

These massage tools are all meant to serve the mutual goals of relieving sore and achy muscles, helping blood circulation, relieving muscle cramps, loosening tight and knotted muscles, and relieving pressure from the massage therapist's hands.

These objects are used in pushing and pulling tissue, and comprise a whole series of objects, including objects as simple as a stones to complex hand-tools with irregularly rounded protrusions for kneading fascia and other connective tissue. These objects usually contact only small surface areas of tissue of several square inches or less, and cannot rapidly be moved across a client's body to apply pressure to multiple situs or simultaneously across larger surface areas on the body.

These tools usually must be lifted and repositioned, and pushed across skin and tissue by the massage therapist is a manner can damage skin and which results in high friction between the tool and tissue, as well as uneven pressure being applied to tissue in the subject area as the object is moved.

None of the tools known in the art comprise slidable, rollable, or rounded foam components for even applying pressure as needed to proficiently practice certain massage techniques.

### SUMMARY OF THE INVENTION

From the foregoing discussion, it should be apparent that a need exists for a rollable massage tool capable of applying moving, even pressure during a massage to a larger surface area without reducing the practical utility of the massage. Beneficially, such a tool would overcome many of the difficulties with prior art by providing a means for massage therapists to transport and use the tool, and rapidly apply pressure to a larger surface area of tissue than tools known in the art.

The present invention has been developed in response to the present state of the art, and in particular, in response to the problems and needs in the art that have not yet been fully solved by currently available information management systems. Accordingly, the present invention has been developed to provide a roller massage tool comprising an elongated cylindrical component mounted between a first handle and a second handle, the cylindrical component axially rotatable about a longitudinal axis extending from a first handle to a second handle, the cylindrical component fabricated from one or more of elastomeric foam and silicone gel.

The roller massage tool further comprises an inner shaft traversing the longitudinal axis of the cylindrical component; and a first handle comprising a planar inside surface, the first handle detachably connected on its inside surface to a first end of the inner shaft, the first handle bored on its inside surface to form an annular recess for receiving one end of the inner shaft.

The roller massage tool further comprises a first ring mounted around the first end of the inner shaft between the cylindrical component and the first handle; and a second handle comprising a planar inside surface, the second handle detachably connected on its inside surface to a second end of the inner shaft, the second handle bored on its inside surface to form an annular recess for receiving one end of the inner shaft such that the inside surface of the second handle is disposed to face the inside surface of the first handle; and a second ring mounted around the second end of the inner shaft between the cylindrical component and the second handle.

In various embodiments of the present invention, the cylindrical massage tool further comprises an inflatable bladder for applying predetermined pressure during massage therapy. The first handle and the second handle may also comprise batteries, and the cylindrical component may comprise one or more of a heating element and vibrator.

The handles of the cylindrical massage may comprise two hemispheres detachably connectable around the inner shaft which may comprises rounded, blunt outside lateral ends for applying pressure directly to a client along the longitudinal axis.

The rings may be removabley and insertabley connected within an annularity bored into the cylindrical component.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top elevational perspective view of an assembled cylindrical roller massage tool in accordance with the present invention;

FIG. 2 is a top elevational perspective view of a disassembled cylindrical roller massage tool in accordance with the present invention;

FIG. 3A is a cross-sectioned perspective view of a cylindrical roller massage tool in accordance with the present invention;

FIG. 3B is a cross-sectioned perspective view of a cylindrical roller massage tool in accordance with the present invention;

FIG. 3C is a cross-sectioned perspective view of a cylindrical roller massage tool in accordance with the present invention; and

FIG. 3D is a cross-sectioned perspective view of a cylindrical roller massage tool in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

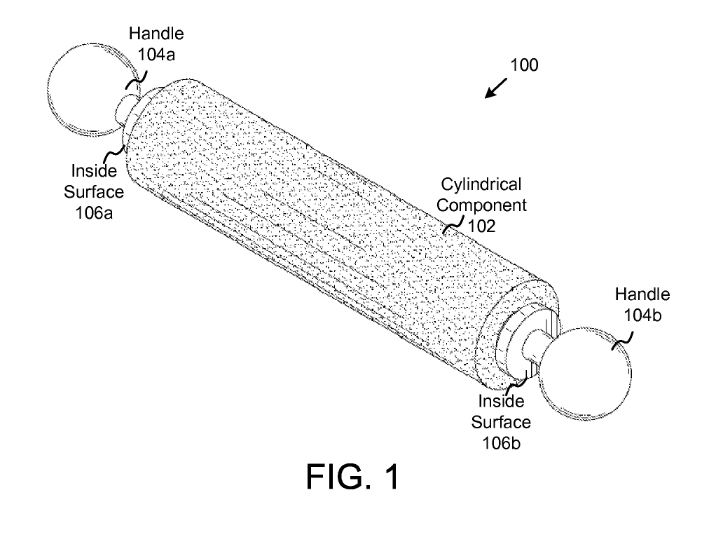

FIG. 1 is a top elevational perspective view of an assembled cylindrical roller massage tool 100 in accordance with the present invention. The cylindrical roller massage tool 100 comprises a cylindrical component 102, a handle 104a, a handle 104b, an inside surface 106a, and an inside surface 106b.

The cylindrical component 102 is elongated across its longitudinal axis. The cylindrical component 102 may be fabricated from polyurethane foam, rubber, silicone gel, foam, and the like. In various embodiments of the present invention, the cylindrical component is between one inch and two feet in length. The cylindrical component 102 is traversed interiorially by a pipe or tube axially rotatable about an inner shaft.

In some embodiments of the present invention, this cylindrical component 102 comprises a bladder filled with compressed air. In some embodiments of the present invention, the cylindrical component 102 is inflatable using means known to those of skill in the art.

The longitudinal axis of the massage tool 100 runs from the handle 104a to the handle 104b. The handles 104a-b comprise an outer surface, or shell, made of rubber, leather and/or another durable material. The handles 104a-b, in the shown embodiment, are spherical in shape and fabricated of viscoelastic polyurethane foam, silicone gel, and the like using 3D printing, plastic mold injection, or other means well-known to those of skill in the art.

The handles 104a-b, in some embodiments, comprises semi-flexible exterior surfaces with a hollow core interiorly isolated atmospherically from ambient air. The handles 104a-b, in some embodiments, comprise a power supply such as batteries for powering heating elements, heating coils, or electro-mechanical vibrators inside the cylindrical component 102.

In some embodiments of the present invention, the diameter of the first handle 104a is twenty to fifty percent less than the diameter of the second handle 104b such that either the first handle 104a and/or the first handle 104b can be used to apply pressure to more or less focused surface areas of client tissue during massage therapy.

The handles 104a-b comprise inner surfaces 106a-b and outer surfaces. The outer surfaces serve as tissue engaging components when the massage tool 100 is alternatively used to apply pressure vis-à-vis the handles 104a-b to a client.

The inner surfaces 106a-b are planar and abut the cylindrical component 102.

The outer surface of the handles 104a-b may comprise tread, conical-shaped protrusions, or otherwise textured surfaces for manipulating the skin of clients during massage therapy.

In various embodiments of the present invention, the outer surfaces of the handles 104a-b may not be planar or substantially planar, but may instead be curved, convex, concave, or otherwise non-planar so as to facilitate the application of a focus pressured to a client.

In some embodiments of the present invention, the handles 104a-b are made of polymers or various species of rubber, in other embodiments the handles 104a-b comprise leather, wood, and/or metal and/or metal alloys.

The apparatus 100 may used to massage muscles and tendons across any part of a client's body, in the back, buttocks, and lower extremities, including those muscles and tendons comprising the same, such the gluteus maximus, gluteus medius, gastrocnemius, soleus, fibularis longus, fibularis brevis, plantaris, flexor hallucis longus, medial malleolus, adductor magnus, semitendinosus, sartorius, plantaris, and the like.

In various embodiments of the present invention, the handles 104a-b may not be spherical, but may be shaped in the form of any other geometric shape conducive to easy gripping, including polyhedral, toroidal polyhedral, and the like.

The massage tool 100 relieves sore and achy muscles and helps blood circulation. The disclosed invention makes an excellent tool for loosening tight and knotted muscles before giving a massage, thus making the massage therapy much easier on the hands of the massage therapist. The massage tool 100 relieves muscle cramps (e.g. Charlie horses) and shin splines. The massage tool 100 is light weight, convenient and easily transportable.

The end cap 206, or ring 206, acts as bearings for the axle.

In some embodiments, a PVC pipe is threaded through the cylindrical component 102, which PVC pipe axially rotates around the inner shaft 202. In some embodiments, a metal or rubber tube is used in place of PVC pipe.

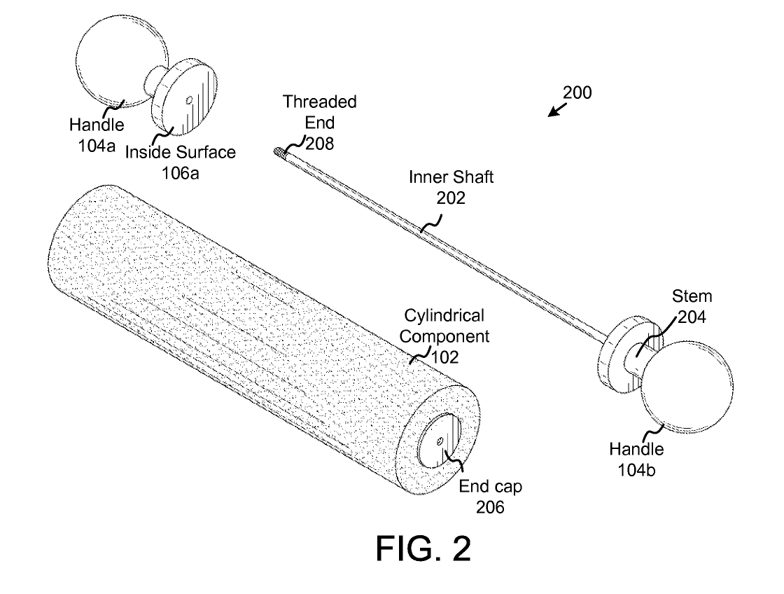

FIG. 2 is a top elevational perspective view of a disassembled cylindrical roller massage tool 200 in accordance with the present invention. The cylindrical roller massage tool 200 comprises a cylindrical component 102, a handle 104a, a handle 104b, an inside surface 106a, an inner shaft 202, a stem 204, and an end cap 206 (or ring 206).

The cylindrical component 102, a handles 104a-b, an inside surface 106a are all substantially described above in relation to FIG. 1.

The inner shaft 202 is fabricated from metal and/or a metal alloy. The shaft 202 is detachable to the handles 104a-b using screws, clamps or rubbers cement.

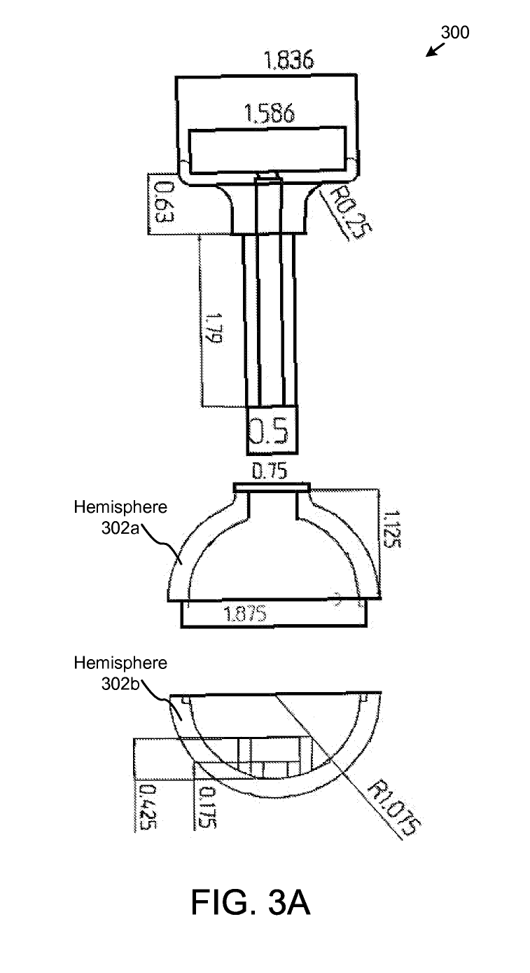

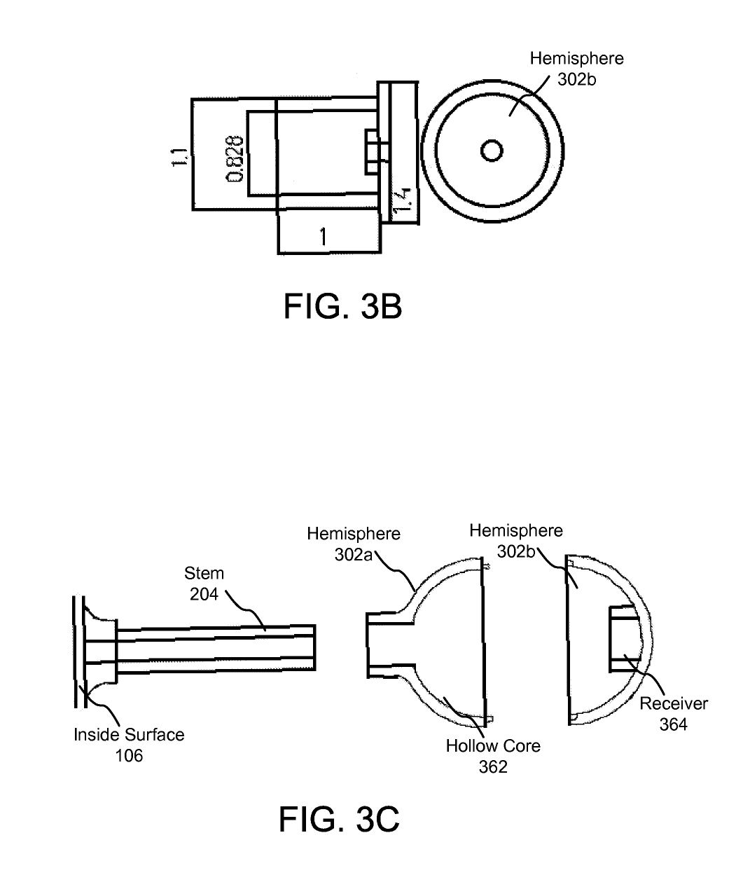

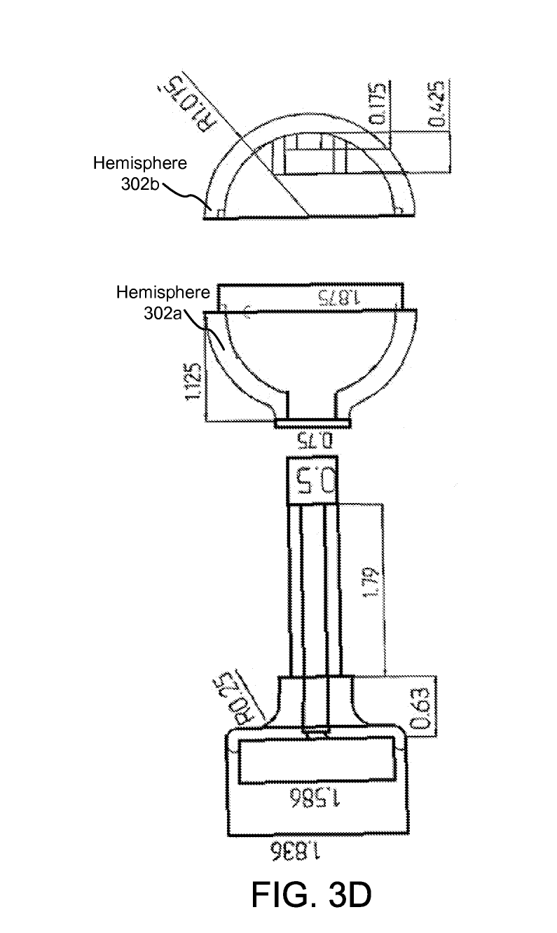

FIG. 3A is a cross-sectioned perspective view of a cylindrical roller massage tool 300 in accordance with the present invention. The measurements shown in the figure are shown units of inches.

The handle 104, in the shown embodiment, comprises two roughly half-spherical, dome-like, convex components. The components attach around the inner shaft 202.

In some embodiments of the present invention, the handles 104a-b are formed to resemble a football, basketball, tennis ball, baseball or the like. In other embodiments, the handles 104a-b comprise a football, baseball, tennis ball and/or the like.

FIG. 3B is a cross-sectioned perspective view of a cylindrical roller massage tool 330 in accordance with the present invention. The measurement shown in the figure are shown units of inches.

Disclosed as shown.

FIG. 3C is a cross-sectioned perspective view of a cylindrical roller massage tool 360 in accordance with the present invention. The measurement shown in the figure are shown units of inches.

Disclosed as shown.

FIG. 3D is a cross-sectioned perspective view of a cylindrical roller massage tool in accordance with the present invention. The measurement shown in the figure are shown units of inches.

Disclosed as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A high-density cylindrical massage tool for applying pressure during massage therapy comprising:
an elongated cylindrical component mounted between a first handle and a second handle, the cylindrical component axially rotatable about a longitudinal axis extending from a first handle to a second handle, the cylindrical component fabricated from one or more of elastomeric foam and silicone gel;
an inner shaft traversing the longitudinal axis of the cylindrical component;
a first handle comprising a planar inside surface, the first handle detachably connected on its inside surface to a first end of the inner shaft, the first handle bored on its inside surface to form an annular recess for receiving one end of the inner shaft;
a first ring mounted around the first end of the inner shaft between the cylindrical component and the first handle;
a second handle comprising a planar inside surface, the second handle detachably connected on its inside surface to a second end of the inner shaft, the second handle bored on its inside surface to form an annular recess for receiving one end of the inner shaft such that the inside surface of the second handle is disposed to face the inside surface of the first handle; and
a second ring mounted around the second end of the inner shaft between the cylindrical component and the second handle.

2. The high-density cylindrical massage tool of claim 1, wherein the cylindrical component further comprises an inflatable bladder for applying predetermined pressure during massage therapy.

3. The high-density cylindrical massage tool of claim 1, wherein one or more of the first handle and the second handle comprise batteries.

4. The high-density cylindrical massage tool of claim 3, wherein the cylindrical component further comprises one or more of a heating element and vibrator.

5. The high-density cylindrical massage tool of claim 1, wherein the handles comprise two hemispheres detachably connectable around the inner shaft.

6. The high-density cylindrical massage tool of claim 1, wherein the handles comprises rounded, blunt outside lateral ends for applying pressure directly to a client along the longitudinal axis.

7. The high-density cylindrical massage tool of claim 1, wherein the rings are removabley and insertabley connected within an annularity bored into the cylindrical component.
